(19) United States
(12) Patent Application Publication
(10) Pub. No.: US 2015/0339166 A1
(43) Pub. Date: Nov. 26, 2015

(54) MEMORY MANAGEMENT FOR VIRTUAL MACHINES

(71) Applicant: International Business Machines Corporation, Armonk, NY (US)

(72) Inventors: Matt R. Hogstrom, Cary, NC (US); Mihir R. Shah, Raleigh, NC (US); Nikola Vouk, Cary, NC (US); Meeta Yadav, Cary, NC (US)

(21) Appl. No.: 14/637,428

(22) Filed: Mar. 4, 2015

Related U.S. Application Data
(63) Continuation of application No. 14/282,114, filed on May 20, 2014.

(51) Int. Cl. G06F 9/50; G06F 9/455

(52) U.S. Cl. CPC G06F 9/5016; G06F 9/45558; G06F 2009/45562; G06F 2009/45583

(57) ABSTRACT

Embodiments of the disclosure relate to managing a memory of a server hosting a plurality of virtual machines. Aspects include receiving a plurality of data pages from each of the plurality of virtual machines to be stored in the memory, filtering each the plurality of data pages into one of a plurality of pools of data pages including a pool of potentially identical data pages, and evaluating the data pages in the pool of potentially identical data pages to identify one or more duplicate data pages and one or more similar data pages. Aspects further include coalescing data pages identified as duplicate data pages and encoding differences for data pages identified as similar pages.

### DOMESTIC PRIORITY

This application is a continuation of the legally related U.S. application Ser. No. 14/282,114 filed May 20, 2014, which is fully incorporated herein by reference.

### BACKGROUND

The present disclosure relates to memory management, and more specifically, to the management of memory for a server hosting a plurality of virtual machines.

Virtualization technology has matured significantly over the past decade and has become pervasive within the service industry. Current research and development activity is now focused on optimizing the virtual environment to enable more virtual machines to be packed on a single server. By increasing the number of virtual machines on a server the power consumed in the data center environment can be reduced, the cost of the virtualized solution can also be reduced and to the available computing resources can be used more efficiently.

As shown in to FIG. 1, a block diagram of a server 100 is shown. As illustrated the server 100 includes a plurality of virtual machines 102 that are operating on the server 100. In exemplary embodiments, the server 100 includes a memory 104 that stores data pages 110 that are used by the virtual machines 102. Each of the plurality of virtual machines 102 includes operating system 106 and a plurality of applications 108 that are being executed by the virtual machine 102. In exemplary embodiments, both the operating system 106 and the applications 108 utilize the memory 104 by storing data pages 110 needed for operation. In general, the operating system 106 and applications 108 are increasingly becoming more resource intensive and require significant amounst of memory 104. As a result, the amount of available memory 104 is a limiting factor on the number of virtual machines 102 that can be places on a server 100

As a result of the plurality of virtual machines 102 sharing the memory 104, the memory 104 includes a lot of data pages 110 which may be identical or very similar. The storage of potentially duplicate data pages 110 by virtual machines 102 in the memory 104 is an inefficient use of the memory 104.

### SUMMARY

According to one embodiment, a method for managing a memory of a server hosting a plurality of virtual machines includes receiving a plurality of data pages from each of the plurality of virtual machines to be stored in the memory and filtering each the plurality of data pages into one of a plurality of pools of data pages including a pool of potentially identical data pages. The method also includes evaluating the data pages in the pool of potentially identical data pages to identify one or more duplicate data pages and one or more similar data pages, coalescing data pages identified as duplicate data pages and encoding differences for data pages identified as similar pages.

According to another embodiment, a computer program product for managing a memory of a server hosting a plurality of virtual machines, the computer program product including a tangible storage medium readable by a processing circuit and storing instructions for execution by the processing circuit for performing a method that includes receiving a plurality of data pages from each of the plurality of virtual machines to be stored in the memory and filtering each the plurality of data pages into one of a plurality of pools of data pages including a pool of potentially identical data pages. The method also includes evaluating the data pages in the pool of potentially identical data pages to identify one or more duplicate data pages and one or more similar data pages, coalescing data pages identified as duplicate data pages and encoding differences for data pages identified as similar pages.

According to a further embodiment, a system for managing a memory of a server hosting a plurality of virtual machines having a processor configured to perform a method receiving a plurality of data pages from each of the plurality of virtual machines to be stored in the memory and filtering each the plurality of data pages into one of a plurality of pools of data pages including a pool of potentially identical data pages. The method also includes evaluating the data pages in the pool of potentially identical data pages to identify one or more duplicate data pages and one or more similar data pages, coalescing data pages identified as duplicate data pages and encoding differences for data pages identified as similar pages.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram illustrating a server having a plurality of virtual machines;

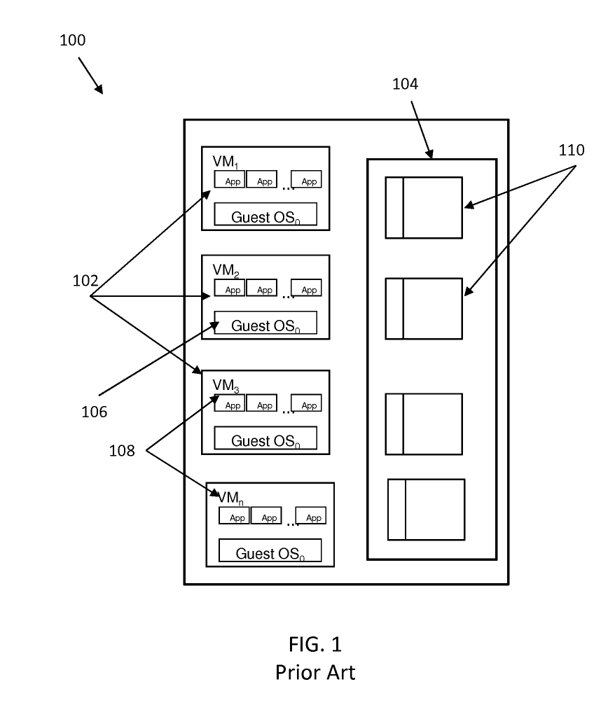

FIG. 2 is a block diagram illustrating one example of a processing system for practice of the teachings herein;

FIG. 3 is a flow diagram illustrating a method managing a memory of a server hosting a plurality of virtual machines in accordance with an exemplary embodiment; and

FIG. 4 is a block diagram illustrating the memory of a server used by a plurality of virtual machines in accordance with an exemplary embodiment.

### DETAILED DESCRIPTION

In accordance with exemplary embodiments of the disclosure, methods, systems and computer program products for managing a memory of a server hosting a plurality of virtual machines are provided. In exemplary embodiments, managing the memory includes reducing, and potentially, eliminating data redundancy in the memory of the server. The data redundancy is reduced by filtering the memory pages used by each of the virtual machines on the server into separate pools of pages. The separate pools of pages include potentially identical pages, similar pages, ones pages, zeros pages and pre-defined content pages. In exemplary embodiments, the potentially identical pages are further processed and actual identical pages are identified and any duplicate pages are discarded. In exemplary embodiments, similar pages are delta encoded to reduce storage requirements. In exemplary embodiments, pre-defined content pages, ones pages and zero pages are compressed and any duplicates of the pre-defined content pages, ones pages and zero pages are discarded. In exemplary embodiments, pages that are not filtered into one of the separate pools of pages may be compressed by analyzing and eliminating repetitive content within the page.

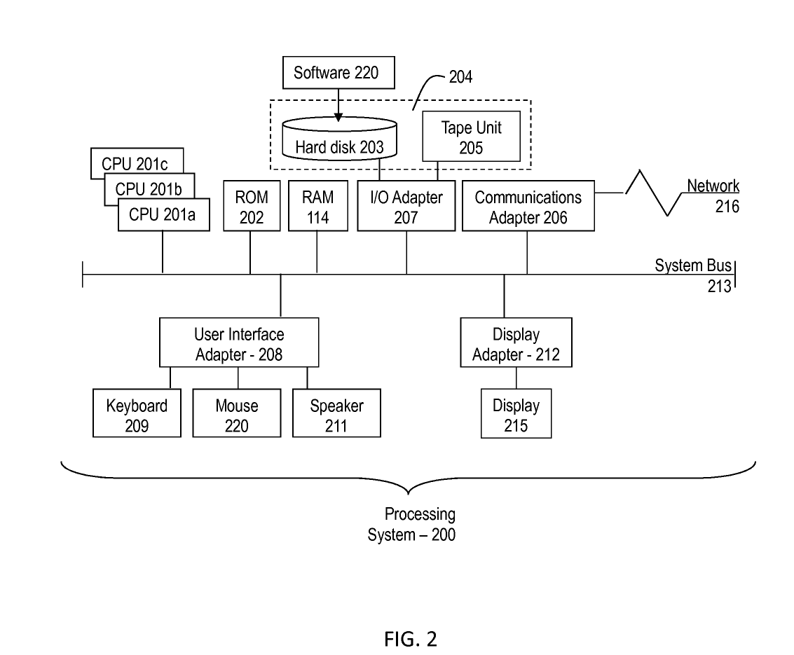

Referring to FIG. 2, there is shown an embodiment of a processing system 200 for implementing the teachings herein. In this embodiment, the system 200 has one or more central processing units (processors) 201a, 201b, 201c, etc. (collectively or generically referred to as processor(s) 201). In one embodiment, each processor 201 may include a reduced instruction set computer (RISC) microprocessor. Processors 201 are coupled to system memory 214 and various other components via a system bus 213. Read only memory (ROM) 202 is coupled to the system bus 213 and may include a basic input/output system (BIOS), which controls certain basic functions of system 200.

FIG. 2 further depicts an input/output (I/O) adapter 207 and a network adapter 206 coupled to the system bus 213. I/O adapter 207 may be a small computer system interface (SCSI) adapter that communicates with a hard disk 203 and/or tape storage drive 205 or any other similar component. I/O adapter 207, hard disk 203, and tape storage device 205 are collectively referred to herein as mass storage 204. Software 220 for execution on the processing system 200 may be stored in mass storage 204. A network adapter 206 interconnects bus 213 with an outside network 116 enabling data processing system 200 to communicate with other such systems. A screen (e.g., a display monitor) 215 is connected to system bus 213 by display adaptor 212, which may include a graphics adapter to improve the performance of graphics intensive applications and a video controller. In one embodiment, adapters 207, 206, and 212 may be connected to one or more I/O busses that are connected to system bus 213 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 213 via user interface adapter 208 and display adapter 212. A keyboard 209, mouse 210, and speaker 211 all interconnected to bus 213 via user interface adapter 208, which may include, for example, a Super I/O chip integrating multiple device adapters into a single integrated circuit.

Thus, as configured in FIG. 2, the system 200 includes processing capability in the form of processors 201, storage capability including system memory 214 and mass storage 204, input means such as keyboard 209 and mouse 210, and output capability including speaker 211 and display 215. In one embodiment, a portion of system memory 214 and mass storage 204 collectively store an operating system such as the AIX® operating system from IBM Corporation to coordinate the functions of the various components shown in FIG. 2.

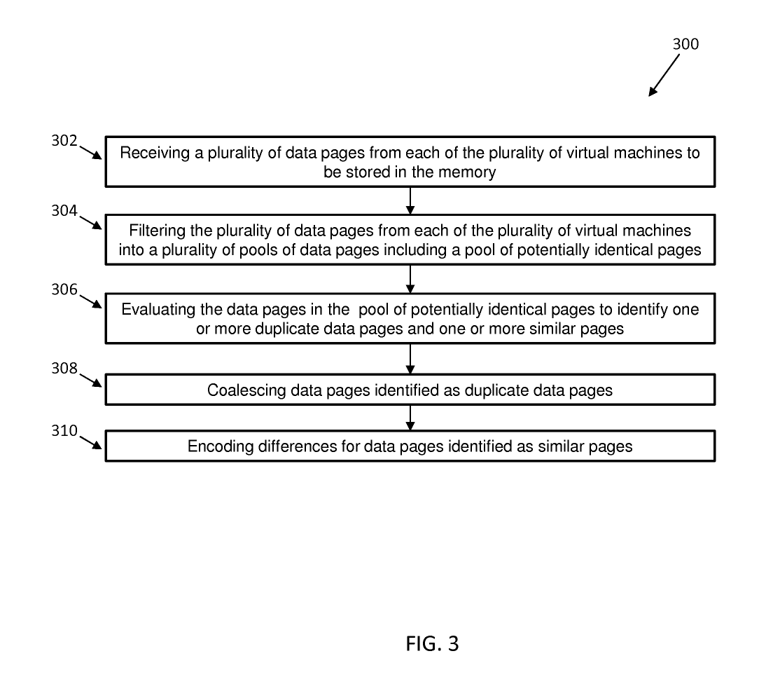

Referring now to FIG. 3, a flow chart illustrating a method 300 for managing a memory of a server hosting a plurality of virtual machines in accordance with an exemplary embodiment is shown. As shown at block 302, the method 300 includes receiving a plurality of data pages from each of the plurality of virtual machines to be stored in the memory. Next, as shown at block 304, the method 300 includes filtering the plurality of data pages from each of the plurality of virtual machines into a plurality of pools of data pages including a pool of potentially identical pages. In exemplary embodiments, the plurality of pools of data pages may also include, but is are not limited to, a pool of similar pages, a pool of zero pages, a pool of ones pages, and a pool of pre-defined content pages. In exemplary embodiments, the filtering of the plurality of data pages is performed by a finger printing technique that filters pages based on Bloom filters and hash functions of each of the pages.

In exemplary embodiments, the filtering of the data pages also includes computing a similarity factor for each of the plurality of data pages. The similarity factor that is calculated for each of the pages is used to determine which pools of data pages that the data page is assigned to. In exemplary embodiments, multiple threshold values may be used in the filtering process. For example, if two data pages have a similarity factor of 1 the data pages are assigned to a potentially identical pages pool. Likewise, if two data pages have a similarity factor of less than 1 but greater than 0.75 the data pages are assigned to a similar pages pool. As will be understood by those of ordinary skill in the art, the similarity factor thresholds used for identifying potentially identical and similar data pages can be adjusted to achieve a desired set of results.

Continuing with reference to FIG. 3, as shown at block 306, the method 300 includes evaluating the data pages in the pool of potentially identical pages to identify duplicate data pages and similar pages. Next, as shown at block 308, the method 300 includes coalescing data pages identified as duplicate data pages. In exemplary embodiments, coalescing the data pages identified as duplicate pages includes storing a single copy of a data page and discarding all identifed duplicates of the data page.

In exemplary embodiments, each of the data pages received is compared with data pages that contain all zero values, all one values, or some pre-defined content. If a data page has a similarity factor of 1 with the data page that contains all zero values, the data page is assigned to the zero page pool. If a data page has a similarity factor of 1 with the data page that contains all one values, the data page is assigned to the one page pool. Likewise, if a data page has a similarity factor of 1 with the data page that contains a pre-defined content, the data page is assigned to the pre-defined content page pool. As used herein a pre-defined content page is a data page that stores content used or seen repeatedly. For example, a pre-defined content page may include common data that is used by the operating system of each of the plurality of virtual machines.

In exemplary embodiments, the data pages in the pool of zero pages, the pool of ones pages, and the pool of pre-defined content pages are also coalesced. For example, only one data page containing all ones is stored, one data page containing all zeroes is stored, and one data page having pre-defined content is stored. All duplicate data pages containing all ones, zeroes, or pre-defined content are discarded.

Continuing with reference to FIG. 3, as shown at block 310, the method 300 also includes encoding differences for data pages identified as similar pages. In exemplary embodiments, the process of encoding differences incudes storing one of the similar pages is in the memory and calculating and storing the difference between the remaining similar pages and the stored page. In exemplary embodiments, calculating the difference between the remaining similar pages and the stored page may be performed by delta encoding. By storing only a single one of the similar data pages and the encoded difference for the other similar data pages, the other data pages are effectively compressed and the amount of memory need to store the group of similar data pages is reduced.

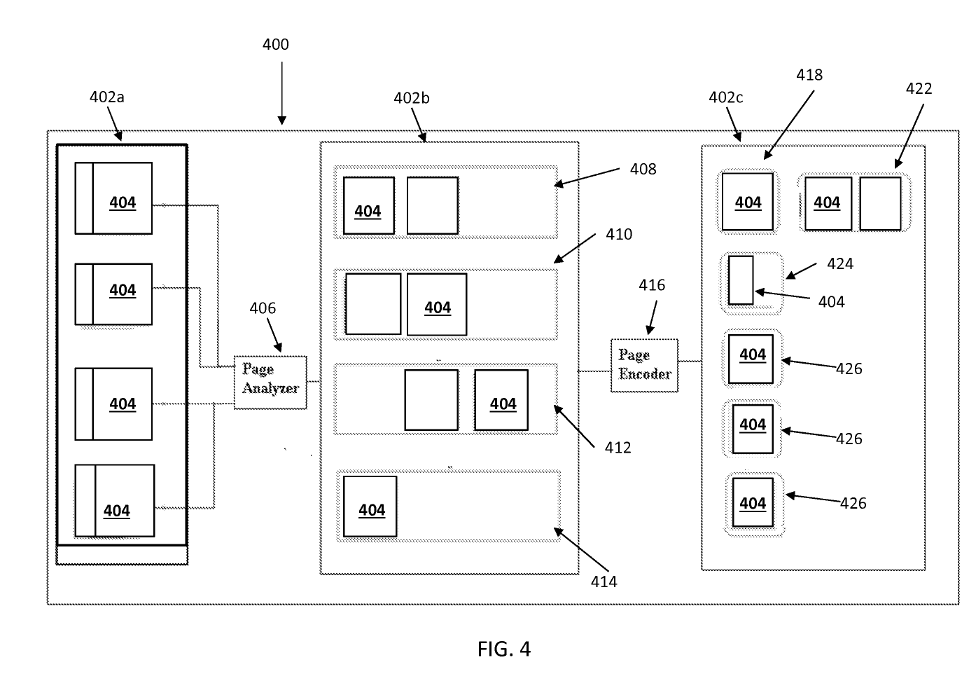

Referring now to FIG. 4 is a block diagram illustrating the memory of a server 400 used by a plurality of virtual machines in accordance with an exemplary embodiment. As illustrated, a memory 402a includes a plurality of data pages 404 received from each of a plurality of virtual machines. The server 400 also includes a page analyzer 406 which filters the data pages 404 into one of a plurality of page pools. In exemplary embodiments, the page analyzer 406 uses a combination of hash functions and Bloom filters to quickly and efficiently compute similarity indexes and filter pages based on this information into different page pools in memory 402b. In exemplary embodiments, the page pools may include, but are not limited to, a potentially identical page pool 408, a similar page pool 410, a ones page pool 412, a zeroes page pool 414 and a pre-defined content page pool (not shown).

The server 400 also includes a page encoder 416 which performs further processing on each of the data pages in the plurality of page pools. In exemplary embodiments, the page encoder 416 compares data pages identified as potentially identical to identify data pages that are actually identical and coalesces the actual identical data pages. In addition, the page encoder 416 encodes data pages that are identified as similar data pages by storing one of the similar data pages and calculating and storing the difference between the remaining similar pages and the stored page. In exemplary embodiments, similar data pages may be identified based on being in the similar page pool 410 or may be data pages that were in the potentially identical page pool 408, but which were not determined to be actually identical pages. In exemplary embodiments, calculating the difference between the remaining similar pages and the stored page may be performed by delta encoding. By storing only a single one of the similar data pages and the encoded difference for the other similar data pages, the other data pages are effectively compressed and the amount of memory need to store the group of similar data pages is reduced.

In exemplary embodiments, if a data page is not in the potentially identical pool 408 or the similar page pool 410, the page encoder 415 may analyze the usage history of the data page and based on its usage history the data page may be marked as a candidate for compression. For example, data pages that are not similar or potentially identical to other data pages and which are infrequently accessed may be compressed to save storage space. However, if the data page is accessed frequently, the data page may not be compressed as the processing burden associated with the compression will not likely exceed the benefit of the reduced storage requirement.

Once the page encoder 416 of the server 400 has processed the data pages in each of the different pools, the memory 402c includes a single copy of any identical pages 418, encoded similar data pages 424, a single zeroes page 424, a single ones 426 and a single copy of any pre-defined content pages 428. In exemplary embodiments, the memory 402c also includes pages 422 that were not filtered into one of the separate pools, which may have be compressed by analyzing and eliminating repetitive content within the page.

In exemplary embodiments, the two-stage process allows for the management of the data pages to be optimized. For example, in the first, or filtering, stage the burden of deduplication of pages is reduced by using high level filters to sort the pages into pools and the second, or encoding, stage delta encoding is used to reduce the memory used by similar pages. In exemplary embodiments, delta encoding offers substantial data compression improvement compared to other known compression techniques. For example, in tested data sets delta encoding had a twenty to fifty percent higher compression ratio compared to gzip.

Although the systems and methods described above have been discussed in reference to managing a memory in a virtual environment system, those of ordinary skill in the art will appreciate that the systems and methods can also be used in a memory optimization system in non-virtual environments. For example, the methods and systems described herein may be used to reduce the bandwidth needed for a data transmission over network for updates of firmware/operating systems/virtual environments by reducing data redundancy.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method for managing a memory of a server hosting a plurality of virtual machines comprising:
receiving a plurality of data pages from each of the plurality of virtual machines to be stored in the memory;
filtering each the plurality of data pages into one of a plurality of pools of data pages including a pool of potentially identical data pages;
evaluating the data pages in the pool of potentially identical data pages to identify one or more duplicate data pages and one or more similar data pages;
coalescing data pages identified as duplicate data pages; and
encoding differences for data pages identified as similar pages.

2. The method of claim 1, wherein the filtering of each of the plurality of data pages comprises performing a Bloom filter and hash function on each of the plurality of data pages.

3. The method of claim 1, wherein the filtering of each of the plurality of data pages comprises computing a similarity factor for each of the plurality of data pages.

4. The method of claim 3, wherein the filtering comprises placing a data page into a pool of similar data pages if the similarity factor for a data page exceeds a minimum threshold value.

5. The method of claim 1, wherein the plurality of pools of data pages further includes a pool of ones data pages, a pool of zeroes data pages and a pool of pre-defined content data pages.

6. The method of claim 5, further comprising coalescing data pages in the pool of ones data pages and coalescing data pages in the pool of zeroes data pages.

7. The method of claim 1, wherein encoding differences for data pages identified as similar pages incudes storing one of the similar data pages is in the memory and calculating and storing the difference between each remaining similar page and the stored page.

8. The method of claim 7, wherein calculating the difference between the remaining similar pages and the stored page comprises delta encoding.
